(19) United States
(12) Patent Application Publication
(10) Pub. No.: US 2010/0307905 A1
(43) Pub. Date: Dec. 9, 2010

(54) KEYSWITCH AND KEYBOARD

(76) Inventor: Yi-Chen Wang, Taoyuan (TW)

Correspondence Address: NORTH AMERICA INTELLECTUAL PROPERTY CORPORATION, P.O. BOX 506, MERRIFIELD, VA, 22116, US

(21) Appl. No.: 12/791,824

(22) Filed: Jun. 1, 2010

(30) Foreign Application Priority Data
Jun. 6, 2009 (TW) 098210057

(51) Int. Cl. H01H 13/76; H01H 13/14

(52) U.S. Cl. 200/5 A; 200/341

(57) ABSTRACT

A keyswitch includes a keyswitch member and a base. The keyswitch member includes a first connecting portion and a second connecting portion. The base includes a sliding portion and a fixing portion. The sliding portion is for adjusting a height of the keyswitch member. The sliding portion includes a step portion and a protrusion portion. The first connecting portion is movably disposed in the step portion. The step portion includes a flat structure and a reversed L-shaped structure. The protrusion portion is adjacent to the step portion. The protrusion portion restrains the first connecting portion from moving. The fixing portion is disposed on the base relative to the sliding portion. A hole is formed on the fixing portion. The second connecting portion is pivotally connected to the fixing portion via the hole.

### BACKGROUND OF THE INVENTION

1. Field of the Invention

The invention relates to a keyswitch and a keyboard and, more particularly, to a sliding portion of a base of a keyswitch, wherein the sliding portion has a step portion and a protrusion portion for controlling a height of the keyswitch.

2. Description of the Prior Art

Recently, many data processing devices, such as, personal computers, notebook computers, smart phones and so on, have been developed as technology progressing. Many input devices are also designed corresponding to the variety of the data processing devices. A keyboard is the most common input device in variety of personal computers and notebook computers.

Referring to FIG. 1A, FIG. 1A is a schematic diagram illustrating a base 22 of a conventional keyboard. As shown in FIG. 1A, the base 22 comprises a step portion 220 and a fixing portion 222. A second connecting portion of a keyswitch member (not shown) can be movably disposed in the step portion 220. A hole 2220 is formed on the fixing portion 222, and a first connecting portion of the keyswitch member can be pivotally connected to the fixing portion 222 via the hole 2220.

Referring to FIG. 1B, FIG. 1B is a schematic diagram illustrating the step portion 220 of FIG. 1A. As shown in FIG. 1B, the conventional step portion 220 comprises a flat structure 2204 and a reversed L-shaped structure 2206. When the step portion 220 is manufactured by a series of manufacturing processes, a vertical surface of the reversed L-shaped structure 2206 may fail to meet the design standard due to the mold design or a long term wearing of the mold.

In practical application, if the vertical surface of the reversed L-shaped structure 2206 can not meet the design standard (the design standard is 90 degrees between the vertical surface and the flat structure 2204), the vertical surface will not restrain the second connecting portion from moving certainly, such that a span existed on the base 22 can not be controlled precisely according to the design of the keyswitch.

Generally speaking, the span represents a distance between the hole 2220 and the vertical surface of the reversed L-shaped structure 2206. If the reversed L-shaped structure 2206 tilts, the span will be difficult to be controlled correspondingly. Furthermore, in practical application, if each span on the base 22 of the keyboard is different from each other, each height of the keyswitch will be also different from each other, such that it is inconvenient for a user in operation.

### SUMMARY OF THE INVENTION

Therefore, an objective of the invention is to provide a base applied to a keyswitch and a keyboard. The invention adds a protrusion portion to a sliding portion of the base. The protrusion portion controls the span by utilizing the relation between the protrusion portion and the step portion instead of the vertical surface of the conventional step portion, so as to solve the problem that the span is difficult to be controlled in the prior art.

According to one embodiment, a keyswitch of the invention comprises a keyswitch member and a base. In this embodiment, the keyswitch member comprises a support structure and a keycap, and the support structure has a first support member and a second support member. A first connecting portion and a third connecting portion are disposed on the first support member, a second connecting portion and a fourth connecting portion are disposed on the second support member, and the first support member is pivotally connected to the second support member in a cross way, such that the keyswitch member is capable of moving relative to the base. The third connecting portion and the fourth connecting portion are pivotally connected to the keycap respectively.

The base comprises a sliding portion and a fixing portion. The sliding portion is used for adjusting a height of the keyswitch member. The fixing portion is disposed on the base relative to the sliding portion. The sliding portion comprises a step portion and a protrusion portion. The first connecting portion is movably disposed in the step portion. The step portion comprises a flat structure and a reversed L-shaped structure. The protrusion portion is adjacent to the step portion. The protrusion portion restrains the first connecting portion from moving. A hole is formed on the fixing portion. The second connecting portion is pivotally connected to the fixing portion via the hole.

According to another embodiment, a keyboard of the invention comprises a plurality of keyswitch members and a base. The keyswitch member comprises a support structure and a keycap, the support structure has a first support member and a second support member. A first connecting portion and a third connecting portion are disposed on the first support member, a second connecting portion and a fourth connecting portion are disposed on the second support member, and the first support member is pivotally connected to the second support member in a cross way, such that the keyswitch member is capable of moving relative to the base. The third connecting portion and the fourth connecting portion are pivotally connected to the keycap respectively.

The base comprises a plurality of sliding portions and a plurality of fixing portions. One of the sliding portions is used for adjusting a height of the keyswitch member. The sliding portion comprises a step portion and a protrusion portion. The first connecting portion is movably disposed in the step portion. The step portion comprises a flat structure and a reversed L-shaped structure. The protrusion portion is adjacent to the step portion. The protrusion portion restrains the first connecting portion from moving. The plurality of fixing portions is disposed on the base relative to the plurality of sliding portions. A hole is formed on each of the fixing portions. The second connecting portion is pivotally connected to one of the fixing portions via the hole.

As mentioned in the above, since the invention adds the protrusion portion to the sliding portion of the base of the keyswitch and the keyboard, the height of the keyswitch can be controlled better than the prior art. Accordingly, the invention can prevent the drawback of the vertical surface failing to control the height of the keyswitch or the keyboard precisely due to the reversed L-shaped failing to meet the design standard during the manufacturing processes. Besides, the structure of the protrusion portion can be determined according to the material of the base. The shape of the protrusion portion is not limited, so the invention can be utilized flexibly in various statuses.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram illustrating a base of a conventional keyswitch.

FIG. 1B is a schematic diagram illustrating a step portion of FIG. 1A.

FIG. 2A is a schematic diagram illustrating a keyswitch according to a first embodiment of the invention.

FIG. 2B is an exploded view illustrating the keyswitch of FIG. 2A.

FIG. 3A is a schematic diagram illustrating a sliding portion of a first type.

FIG. 3B is a side view illustrating the sliding portion of the first type.

FIG. 4A is a schematic diagram illustrating a sliding portion of a second type.

FIG. 4B is a side view illustrating the sliding portion of the second type.

FIG. 5A is a schematic diagram illustrating a sliding portion of a third type.

FIG. 5B is a side view illustrating the sliding portion of the third type.

FIG. 6A is a schematic diagram illustrating a sliding portion of a fourth type.

FIG. 6B is a side view illustrating the sliding portion of the fourth type.

FIG. 7A is a schematic diagram illustrating a sliding portion of a fifth type.

FIG. 7B is a side view illustrating the sliding portion of the fifth type.

FIG. 8A is a schematic diagram illustrating a sliding portion of a sixth type.

FIG. 8B is a side view illustrating the sliding portion of the sixth type.

FIG. 9 is a schematic diagram illustrating a keyboard according to a second embodiment of the invention.

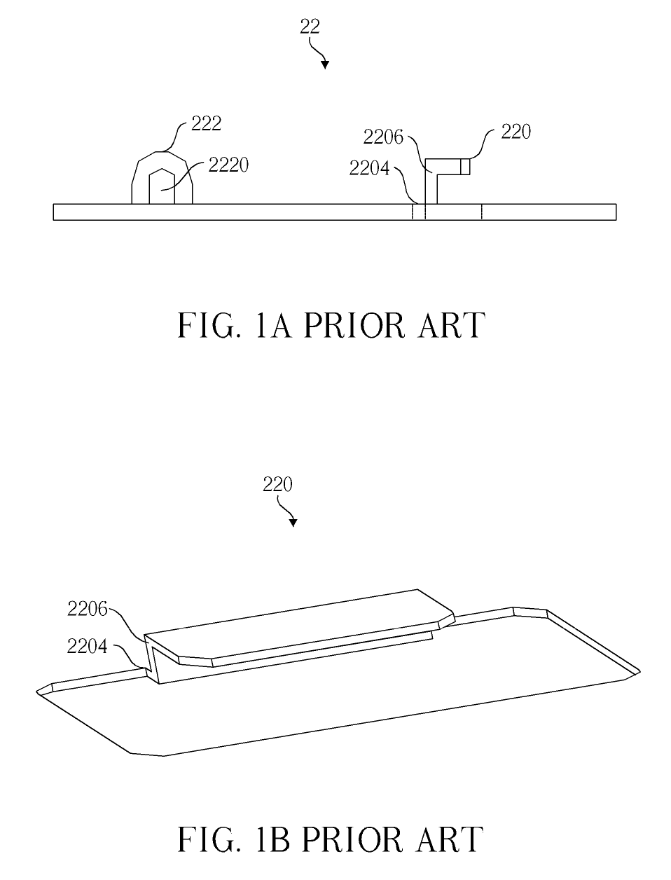

### DETAILED DESCRIPTION

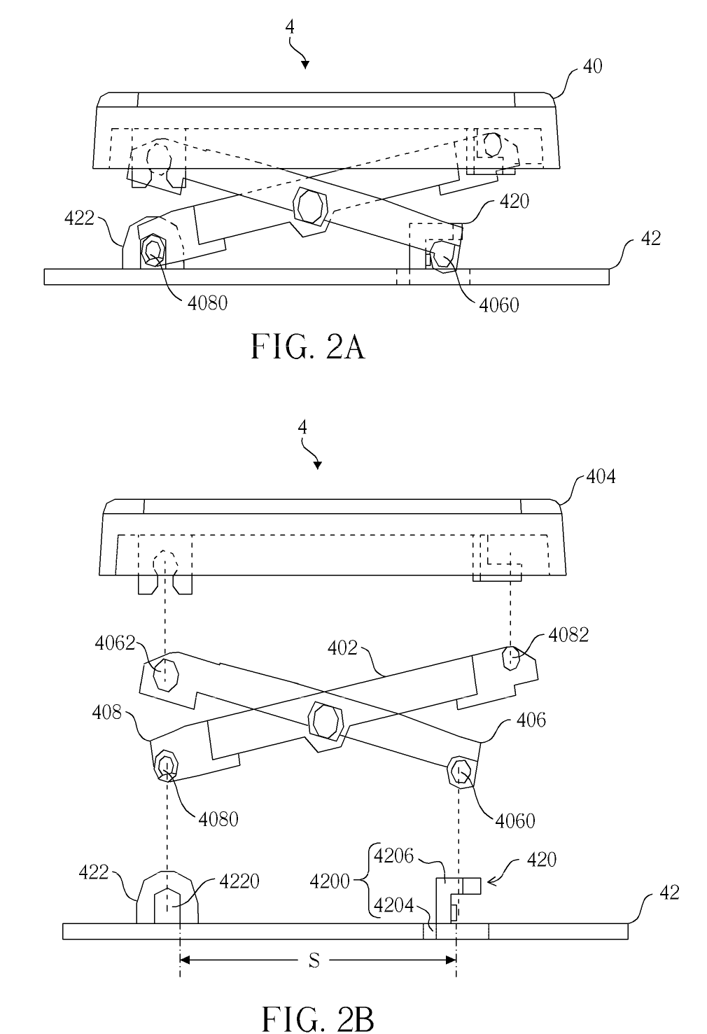

Referring to FIG. 2A and FIG. 2B, FIG. 2A is a schematic diagram illustrating a keyswitch 4 according to a first embodiment of the invention, and FIG. 2B is an exploded view illustrating the keyswitch 4 of FIG. 2A.

As shown in FIG. 2A and FIG. 2B, the keyswitch 4 comprises a keyswitch member 40 and a base 42. The keyswitch member 40 comprises a support structure 402 and a keycap 404. The support structure 402 comprises a first support member 406 and a second support member 408. A first connecting portion 4060 is disposed on one end of the first support member 406, and a third connecting portion 4062 is disposed on the other end of the first support member 406. A second connecting portion 4080 is disposed on one end of the second support member 408, and a fourth connecting portion 4082 is disposed on the other end of the second support member 408.

In this embodiment, the first support member 406 is pivotally connected to the second support member 408 in a cross way, the third connecting portion 4062 is pivotally connected to the key cap 404, and the fourth connecting portion 4082 is movably connected to the key cap 404, such that the keyswitch member 40 is capable of moving relative to the base 42. It should be noted that the invention is not limited to the aforesaid connecting manner.

In this embodiment, the base 42 comprises a sliding portion 420 and a fixing portion 422. The sliding portion 420 is used for adjusting a height of the keyswitch member 40. The sliding portion 420 comprises a step portion 4200 and a protrusion portion 4202. The first connecting portion 4060 is movably disposed in the step portion 4200. The protrusion portion 4202 is adjacent to the step portion 4200, and the protrusion portion 4202 restrains the first connecting portion 4060 from moving. The step portion 4200 comprises a flat structure 4204 and a reversed L-shaped structure 4206.

As shown in FIG. 2B, the fixing portion 422 is disposed on the base 42 relative to the sliding portion 420. A hole 4220 is formed on the fixing portion 422. The second connecting portion 4080 is pivotally connected to the fixing portion 422 via the hole 4220.

In practical application, there is a span S between the protrusion portion 4202 and the hole 4220. In this embodiment, the span S represents a distance between the protrusion portion 4202 and the hole 4220. In other words, the span S represents a minimum distance which the first connecting portion 4060 of the support structure 406 can move on the base 42.

The flat structure 4204 and the reversed L-shaped structure 4206 can be formed integrally by a series of manufacturing processes. The first connecting portion 4060 is movably connected to the reversed L-shaped structure 4206 of the step portion 4200. In practical application, the reversed L-shaped structure 4206 usually fails to meet the design standard due to a long term wearing of the mold, so as to affect the movement of the first connecting portion 4060. Therefore, the protrusion portion 4202 of the invention is utilized to improve the problem in the prior art. The structure of the sliding portion 420 of the invention will be depicted as below.

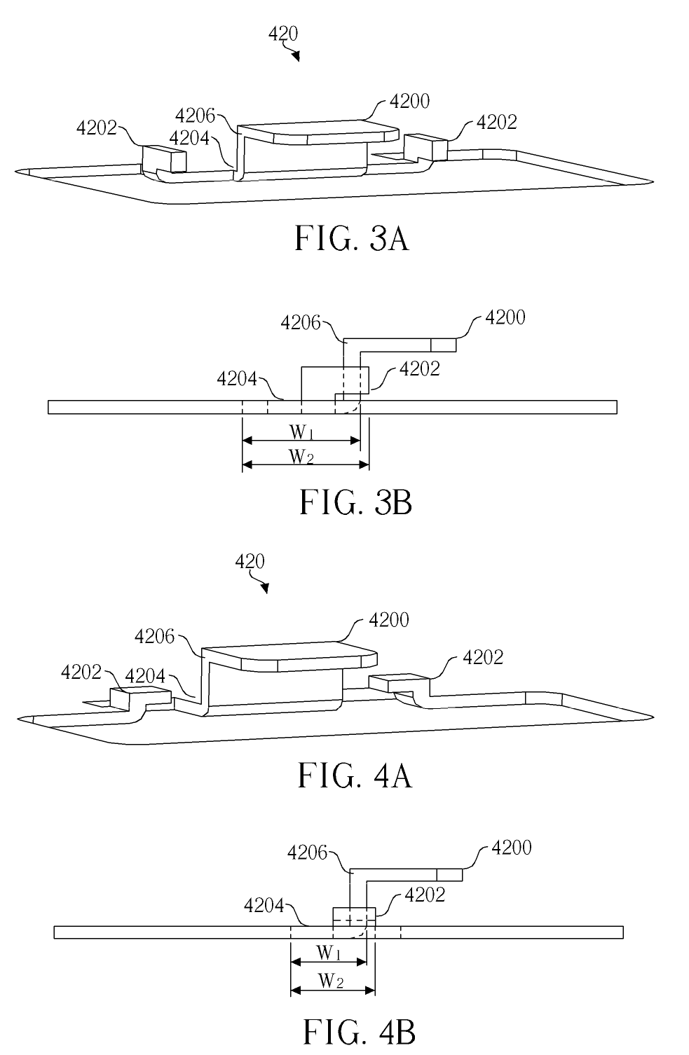

Referring to FIG. 3A and FIG. 3B, FIG. 3A is a schematic diagram illustrating the sliding portion 420 of a first type, and FIG. 3B is a side view illustrating the sliding portion 420 of the first type. As shown in FIG. 3A and FIG. 3B, the sliding portion 420 comprises a step portion 4200 and two protrusion portions 4202. The step portion 4200 consists of the flat structure 4204 and the reversed L-shaped structure 4206. The flat structure 4204 has a first width W1, each of the protrusion portions 4202 has a second width W2, and the second width W2 is larger than the first width W1.

As shown in FIG. 3B, the second width W2 of the protrusion 4202 is extended inside the reversed L-shaped structure 4206. Therefore, the protrusion portion 4202 can restrain the first connecting portion 4060 from moving. Accordingly, each height of the keyswitches 4 will not be affected even if the reversed L-shaped structure 4206 tilts.

Referring to FIG. 4A and FIG. 4B, FIG. 4A is a schematic diagram illustrating a sliding portion 420 of a second type, and FIG. 4B is a side view illustrating the sliding portion 420 of the second type. The structure of the protrusion portion 4202 of the sliding portion 420 is shown in FIG. 4A and FIG. 4B. In practical application, if the base 42 is a thin plate, the structure of the protrusion portion 4202 of the second type can be used to enforce strength of the protrusion portion 4202.

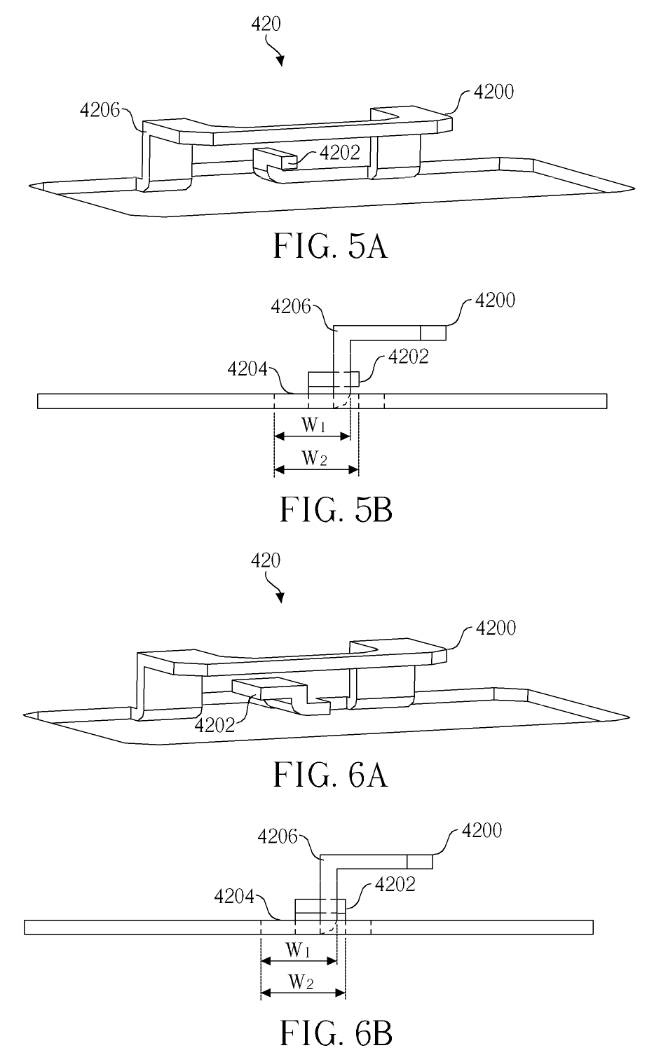

Referring to FIG. 5A, FIG. 5B, FIG. 6A and FIG. 6B, FIG. 5A is a schematic diagram illustrating a sliding portion 420 of a third type, FIG. 5B is a side view illustrating the sliding portion 420 of the third type, FIG. 6A is a schematic diagram illustrating a sliding portion 420 of a fourth type, and FIG. 6B is a side view illustrating the sliding portion 420 of the fourth type. As shown in the aforesaid figures, the sliding portion 420 comprises a step portion 4200 and a protrusion portion 4202. In this embodiment, the middle material of the sliding portion 420 can be cut off to save the material. However, it should be noticed that the structure of the protrusion portion 4202 is identical to the structure of the aforesaid embodiment, and the detailed description thereof will not be depicted here again.

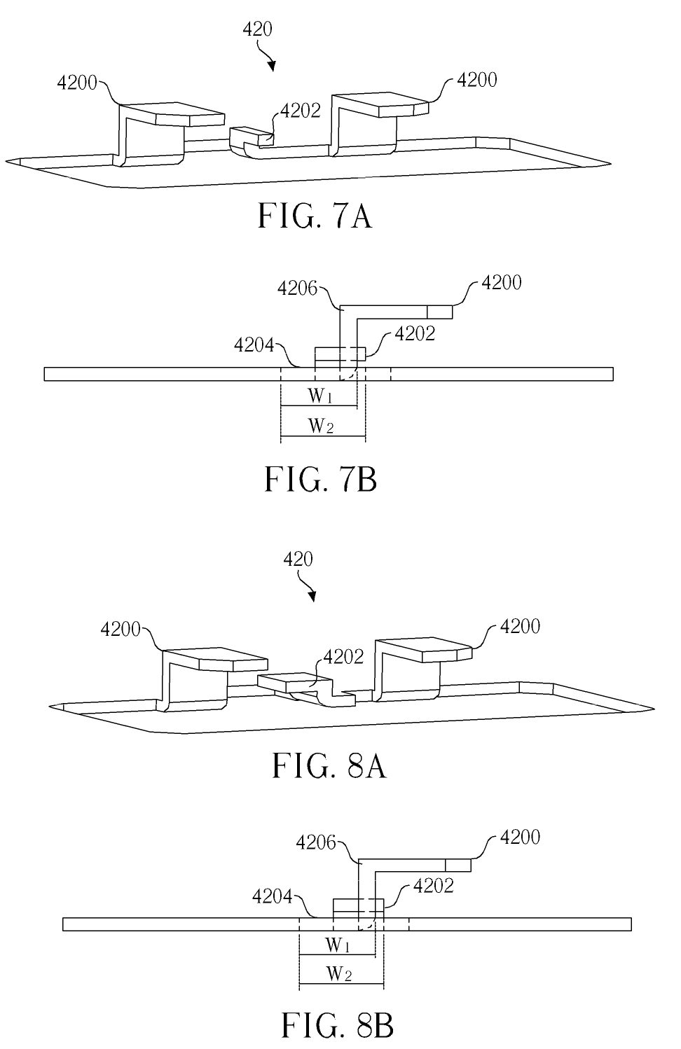

Referring to FIG. 7A, FIG. 7B, FIG. 8A and FIG. 8B, FIG. 7A is a schematic diagram illustrating a sliding portion 420 of a fifth type, FIG. 7B is a side view illustrating the sliding portion 420 of the fifth type, FIG. 8A is a schematic diagram illustrating a sliding portion 420 of a sixth type, and FIG. 8B is a side view illustrating the sliding portion 420 of the sixth type. As shown in the aforesaid figures, the sliding portion 420 comprises two step portions 4200 and a protrusion portion 4202. In this embodiment, the step portion 4200 is cut into two pieces, so as to save more material than the third type and the fourth type. It should be noticed that the structure of the protrusion portion 4202 is identical to the structure of the aforesaid embodiment, and the detailed description thereof will not be depicted here again.

In practical application, the invention utilizes the protrusion portion 4202 to restrain the movement of the support structure 402 of the keyswitch member 40 instead of the vertical surface of the reversed L-shaped structure 4206 of the step portion 4200, so as to adjust the height of the keyswitch 4. Besides, the protrusion portion 4202 can be formed directly on the base 42 without any further manufacturing process. Generally speaking, an upper surface of the protrusion portion 4202 can be, but not limited to, parallel to an upper surface of the base 42.

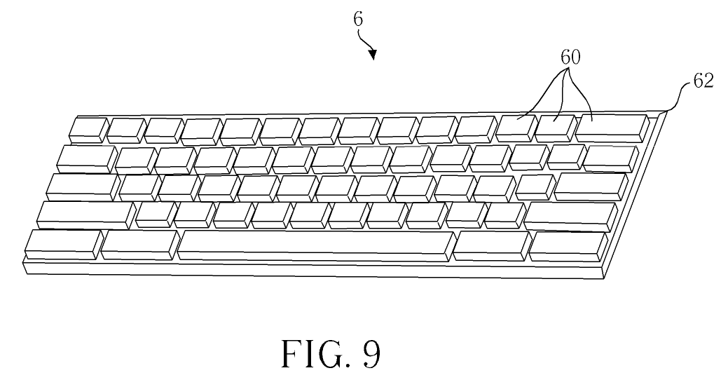

Referring to FIG. 9, FIG. 9 is a schematic diagram illustrating a keyboard 6 according to a second embodiment of the invention. As shown in FIG. 9, the keyboard 6 comprises a plurality of keyswitches 60 and a base 62. The structure of each of the keyswitches 60 of the keyboard 6 is identical to the keyswitch 4 of the aforesaid embodiment, so the detailed description thereof will not be depicted here again, and referring to FIG. 2B as well while reading.

In this embodiment, each of the keyswitch members 60 comprises a support structure and a keycap and the structure thereof is identical to the first embodiment, so it will not be depicted here again. The keyswitch members 60 are disposed on the base 62, and the structure of the base 62 is identical to the first embodiment, so it will not be depicted here again.

In practical application, when the base 62 is finished by a series of manufacturing processes, the protrusion portion can control the height of the keyswitch easily and steadily instead of the vertical surface of the conventional reversed L-shaped structure. In other words, the main function of the protrusion portion of the invention is to control the movement of the support structure of the keyswitch member 60, and the main function of the reversed L-shaped structure is to provide a space for the movement of the support structure. Therefore, all the keyswitches of the keyboard 6 can be controlled in the same height steadily by just paying attention to each width of the protrusion portions.

Compared to the prior art, since the invention adds the protrusion portion to the sliding portion of the base of the keyswitch and the keyboard, the height of the keyswitch can be controlled better than the prior art. Accordingly, the invention can prevent the drawback of the vertical surface failing to control the height of the keyswitch or the keyboard precisely due to the reversed L-shaped failing to meet the design standard during the manufacturing processes. Besides, the structure of the protrusion portion can be determined according to the material of the base. The shape of the protrusion portion is not limited, so the invention can be utilized flexibly in various statuses.

Those skilled in the art will readily observe that numerous modifications and alterations of the device and method may be made while retaining the teachings of the invention.

What is claimed is:

1. A keyswitch comprising:
a keyswitch member comprising a first connecting portion and a second connecting portion; and
a base comprising:
a sliding portion for adjusting a height of the keyswitch member, the sliding portion comprising:
a step portion, the first connecting portion movably disposed in the step portion, the step portion comprising a flat structure and a reversed L-shaped structure; and
a protrusion portion adjacent to the step portion, the protrusion portion restraining the first connecting portion from moving; and
a fixing portion disposed on the base relative to the sliding portion, a hole formed on the fixing portion, the second connecting portion being pivotally connected to the fixing portion via the hole.

2. The keyswitch of claim 1, wherein the flat structure has a first width, the protrusion portion has a second width, and the second width is larger than the first width.

3. The keyswitch of claim 1, wherein the keyswitch member further comprises a support structure and a key cap, the support structure has a first support member and a second support member, the first connecting portion and a third connecting portion are disposed on the first support member, the second connecting portion and a fourth connecting portion are disposed on the second support member, and the first support member is pivotally connected to the second support member in a cross way, such that the keyswitch member is capable of moving relative to the base.

4. The keyswitch of claim 3, wherein the third connecting portion and the fourth connecting portion are pivotally connected to the key cap.

5. The keyswitch of claim 1, wherein there is a span between the protrusion portion and the hole, and the span represents a distance between the protrusion portion and the hole.

6. The keyswitch of claim 1, wherein the flat structure and the reversed L-shaped structure are formed integrally.

7. The keyswitch of claim 1, wherein the second connecting portion is inserted into the hole from a side of the hole, so as to be pivotally connected to the hole.

8. The keyswitch of claim 1, wherein the first connecting portion is movably connected to the reversed L-shaped structure of the step portion.

9. A keyboard comprising:
a plurality of keyswitches, one of the keyswitches comprising:
a keyswitch member, the keyswitch member comprising a first connecting portion and a second connecting portion; and
a base comprising:
a plurality of sliding portions, one of the sliding portions being for adjusting a height of the keyswitch member, one of the sliding portions comprising:
a step portion, the first connecting portion movably disposed in the step portion, the step portion comprising a flat structure and a reversed L-shaped structure; and
a protrusion portion adjacent to the step portion, the protrusion portion restraining the first connecting portion from moving; and
a plurality of fixing portions, each of the fixing portions disposed on the base relative to each of the sliding portions, a hole formed on each of the fixing portions, the second connecting portion being pivotally connected to the fixing portion via the hole.

10. The keyboard of claim 9, wherein the flat structure has a first width, the protrusion portion has a second width, and the second width is larger than the first width.

11. The keyboard of claim 9, wherein the keyswitch member further comprises a support structure and a key cap, the support structure has a first support member and a second support member, the first connecting portion and a third connecting portion are disposed on the first support member, the second connecting portion and a fourth connecting portion are disposed on the second support member, and the first support member is pivotally connected to the second support member in a cross way, such that the keyswitch member is capable of moving relative to the base.

12. The keyboard of claim 11 , wherein the third connecting portion and the fourth connecting portion are pivotally connected to the key cap.

13. The keyboard of claim 9, wherein the second connecting portion is inserted into the hole from a side of the hole, so as to be pivotally connected to the hole.

14. The keyboard of claim 9, wherein there is a span between the protrusion portion and the hole, and the span represents a distance between the protrusion portion and the hole.

15. The keyboard of claim 9, wherein the flat structure and the reversed L-shaped structure are formed integrally.

16. The keyboard of claim 9, wherein the first connecting portion is movably connected to the reversed L-shaped structure of the step portion.
